(19) United States
(12) Patent Application Publication
(10) Pub. No.: US 2014/0056291 A1
(43) Pub. Date: Feb. 27, 2014

(54) COMMUNICATION SERVER

(71) Applicant: JIA TENG TECHNOLOGY CO.,LTD., Taipei City (TW)

(72) Inventors: Ta-Wei HU, Keelung City (TW); Chuan-Chih LIN, Taipei (TW)

(73) Assignee: Jia Teng Technology Co.,Ltd., Taipei City (TW)

(21) Appl. No.: 13/738,135

(22) Filed: Jan. 10, 2013

(30) Foreign Application Priority Data
Aug. 22, 2012 (TW) 101216198

(51) Int. Cl. H04W 84/12

(52) U.S. Cl. CPC H04W 84/12
USPC 370/338

(57) ABSTRACT

A communication server at least includes a processing unit; a radio frequency (RF) unit connected to the processing unit; a network address conversion unit connected to the processing unit; a connection unit connected to the processing unit; and a display unit connected to the processing unit. It can be connected to the Internet network, the household phone, the mobile phone and the Internet phone for the use of communication so that a plurality of users can share the same communication server without any need of other communication equipments, thus achieving purposes of being easy to install, reduced set-up costs, enhanced communication efficiency, lowered call costs and reduce in the waste of resources.

### BACKGROUND OF THE INVENTION

1. Field of the Invention

The present invention relates to a communication server, particularly to a communication server which can be connected to the Internet network, the household phone, the mobile phone and the Internet phone for the use of communication so that a plurality of users can share the same communication server without any need of other communication equipments, thus achieving the purposes of easy to install, reduced set-up costs, enhanced communication efficiency, lowered call costs and reduce in the waste of resources.

2. Description of Related Art

Currently available communication means in the office is majorly a traditional phone. In some cases, although the communication can be made through the computer Skype, MSN and other Internet phones and call costs can be saved compared to traditional telephone, it still cannot fully replace the traditional phone with them because the currently network telephones are based passive way (pull call) which checks at any time if there is external call comes in and thus the computer servers in use always check a waste of resources. This causes the poor phone service quality and working efficiency. Accordingly, office call costs will increase. Moreover, an Internet phone usually requires an IP address and therefore often takes up server resources, which does not comply with the need for large corporate. Even though this problem can be solved by using a network address translator, it is a need to still additionally the network address translator, adding complexity and extra costs to the whole installation. Therefore, the conventional phones or Internet phones cannot meet the requirements for the users in actual use.

For this reason, the inventors has studied and proceeded in-depth discussion, and actively seek approaches for many years engaged in the research and experiences of related industries and manufacturing. After long-term research and efforts in development, the inventors has finally the successfully developed this invention “communication server” which overcomes the shortages in the prior art.

### SUMMARY OF THE INVENTION

A main purpose of this invention is to provide a communication server which can be connected to the Internet network, the household phone, the mobile phone and the Internet phone for the use of communication so that a plurality of users can share the same communication server without any need of other communication equipments, thus achieving the purposes of being easy to install, reduced set-up costs, enhanced communication efficiency, lowered call costs and reduce in the waste of resources.

In order to achieve the above and other objectives, the communication server of the invention at least includes a processing unit; a radio frequency (RF) unit connected to the processing unit; a network address conversion unit connected to the processing unit; a connection unit connected to the processing unit; and a display unit connected to the processing unit.

In one embodiment of the invention, the processing unit, the RF unit, the network address conversion unit, the connection unit and the display unit are combined with a housing each other.

In one embodiment of the invention, the processing unit, the RF unit and the network address conversion unit are disposed in the housing, and the connection unit and the display unit are located at both end surfaces of the housing.

In one embodiment of the invention, the processing unit is a single chip, wafer, or logic circuit, and can further include a reset button provided on one side of the housing.

In one embodiment of the invention, the RF unit is Communication Agreement 802.11, and further contains an antenna located outside of the housing.

In one embodiment of the invention, the connection unit includes a RJ45 connector, a network connector and a power connector respectively located at the end surface of the housing.

In one embodiment of the invention, the display unit contains a plurality of light emitting diodes located at the other end surface of the housing.

### BRIEF DESCRIPTION OF THE DRAWINGS

FIG. 1 is a schematic view of an appearance of a communication server according to the invention.

FIG. 2 is a schematic rear view of a communication server according to the invention.

FIG. 3 is a schematic block diagram of a communication server according to the invention.

FIG. 4 is schematic view of use status of a communication server according to the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

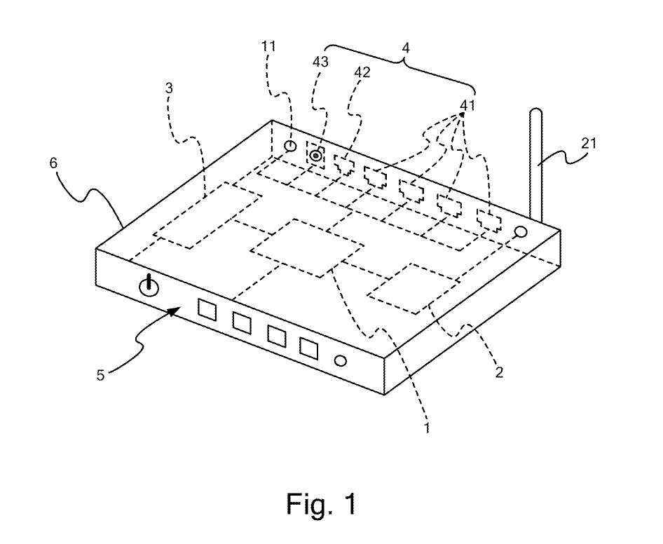

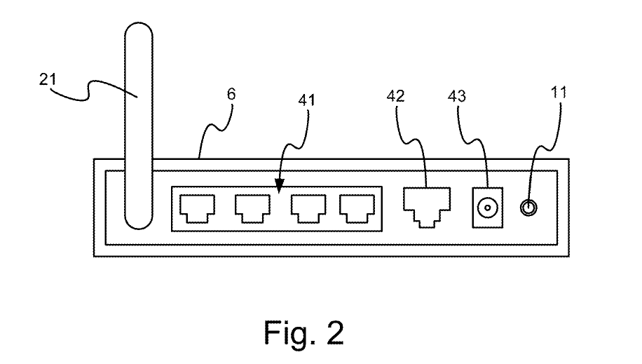

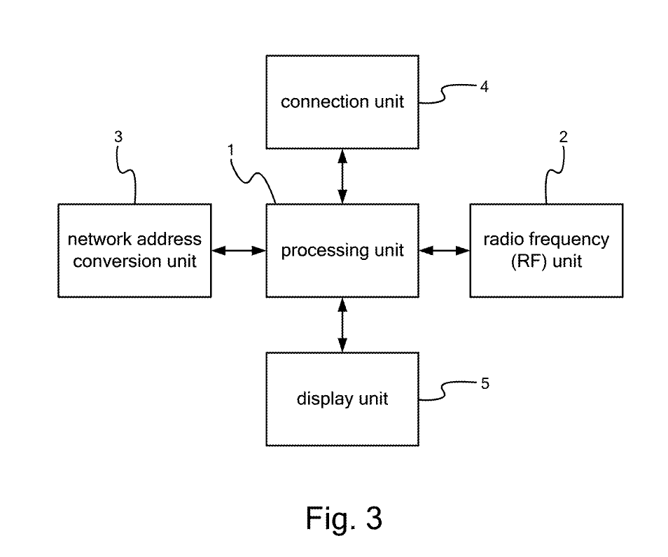

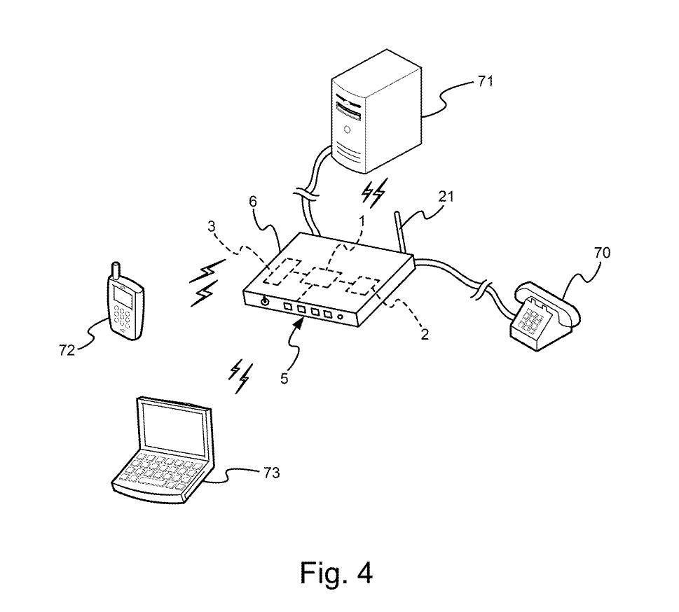

FIG. 1 is a schematic view of an appearance of a communication server according to the invention. FIG. 2 is a schematic rear view of a communication server according to the invention. FIG. 3 is a schematic block diagram of a communication server according to the invention. FIG. 4 is schematic view of use status of a communication server according to the invention. As shown, the communication server at least includes a processing unit 1, a radio frequency (RF) unit 2, a network address conversion unit 3, a connection unit 4, and a display unit 5. The processing unit 1, the RF unit 2, the network address conversion unit 3, the connection unit 4 and the display unit 5 are combined with a housing 6 each other. The processing unit 1, the RF unit 2 and the network address conversion unit 3 are disposed in the housing 6. The connection unit 4 and the display unit 5 are located at both end surfaces of the housing 6.

The processing unit 1 is a single chip, wafer, or logic circuit, and can further include a reset button 11 provided on one side of the housing.

The RF unit 2 is connected to the processing unit 1, and can be Communication Agreement 802.11, for example. The RF unit 2 further contains an antenna 21 located outside of the housing 6.

The network address conversion unit 3 is connected to the processing unit 1.

The connection unit 4 is connected to the processing unit 1, and includes a RJ45 connector 41, a network connector 42 and a power connector 43 respectively located at the end surface of the housing 6.

The display unit 5 is connected to the processing unit 1, and contains a plurality of light emitting diodes located at the other end surface of the housing 6. Thereby, the above-mentioned components constitute a completely new communication server.

When the communication server of the invention is put into practice, the antenna 21 of the RF unit 2, the RJ45 connector 41 and the network connector 42 of the connecting unit 4 are connected to a household phone 70, an Internet network 71, a mobile phone 72 and an Internet phone 73. The power connector 43 is connected to an external power supply. The display unit 5 shows the connection status of being normal or abnormal (identifying by different light colors at different locations). The processing unit 1 has an embedded Linux system or Windows system. When the household phone 70, the Internet network 71, the mobile phone 72 and the Internet phone 73 get through, the processing unit 1 is connected to the network address conversion unit 3 for the use of communication. A plurality of users of the household phone 70, the Internet network 71, the mobile phone 72 and the Internet phone 73 can share the same communication server of the invention without any need of other communication equipments, thus achieving the purposes of being easy to install, reduced set-up costs, enhanced communication efficiency, saved call costs, and reduce in the waste of resources.

In summary, the communication server of the invention can effectively improve the shortcomings of the conventional technology, and can be connected to the Internet network, the household phone, the mobile phone and the Internet phone for the use of communication so that a plurality of users can share the same communication server without any need of other communication equipments, thus achieving the purposes of being easy to install, reduced set-up costs, enhanced communication efficiency, lowered call costs and reduce in the waste of resources. This makes the invention more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A communication server at least comprising a processing unit;
a radio frequency (RF) unit, connected to the processing unit;
a network address conversion unit, connected to the processing unit;
a connection unit, connected to the processing unit; and
a display unit, connected to the processing unit.

2. The communication server of claim 1, wherein the processing unit, the RF unit, the network address conversion unit, the connection unit and the display unit are combined with a housing each other.

3. The communication server of claim 2, wherein the processing unit, the RF unit and the network address conversion unit are disposed in the housing; and
the connection unit and the display unit are located at both end surfaces of the housing.

4. The communication server of claim 2, wherein the processing unit is a single chip, wafer, or logic circuit, and can further include a reset button provided on one side of the housing.

5. The communication server of claim 2, wherein the RF unit is Communication Agreement 802.11, and further contains an antenna located outside of the housing.

6. The communication server of claim 2, wherein the connection unit includes a RJ45 connector, a network connector and a power connector respectively located at the end surface of the housing.

7. The communication server of claim 2, wherein the display unit contains a plurality of light emitting diodes located at the other end surface of the housing.
